(19) United States
(12) Patent Application Publication
(10) Pub. No.: US 2020/0104046 A1
(43) Pub. Date: Apr. 2, 2020

(54) OPPORTUNISTIC DATA CONTENT DISCOVERY SCANS OF A DATA REPOSITORY

(71) Applicant: CA, Inc., Islandia, NY (US)

(72) Inventors: Robin Hopper, Prague (CZ); Victor Muntes, Barcelona (ES)

(73) Assignee: CA, Inc., Islandia, NY (US)

(21) Appl. No.: 16/149,884

(22) Filed: Oct. 2, 2018

(51) Int. Cl. G06F 3/06; G06F 17/30

(52) U.S. Cl. CPC G06F 3/062; G06F 3/0653; G06F 21/60; G06F 17/30339; G06F 3/067; G06F 17/30952

(57) ABSTRACT

An embodiment includes identifying a first location in memory containing first data rows copied from a second location in the memory containing second data rows retrieved from one or more objects in a data repository, selecting a portion of the first data rows to be scanned. The portion of the first data rows correspond to a first object of the one or more objects. The embodiment further includes performing a scan of the portion of the first data rows, calculating a probability that the first object contains sensitive data based, at least in part, on one or more instances of sensitive data identified during the scan, and marking the first object in the data repository with a sensitive data indicator. The sensitive data indicator is based, at least in part, on the probability that the first object contains sensitive data.

### BACKGROUND

The present disclosure relates in general to the field of data storage, and more specifically, to opportunistic data content discovery scans of a data repository.

Mass storage devices (MSDs) are used to store large quantities of data and to enable continuous or near-continuous access to the data. Retailers, government agencies and services, educational institutions, transportation services, and health care organizations are among a few entities that may provide ‘always on’ access to their data by customers, employees, students, or other authorized users. A database is one type data structure used in a data repository to store large quantities of data as an organized collection of information. Typically, databases have a logical structure such that a user accessing the data in the database sees logical data columns arranged in logical data rows.

Entities that maintain or control large data repositories that store private identifiable information (PII) of individuals, typically, perform or cause to be performed some type of data content discovery to identify this sensitive data stored in these data repositories. Similarly, data content discovery may be performed on data repositories to identify other types of sensitive data, such as classified or privileged information, for example. In a database environment, however, read actions can be expensive, can hinder the overall performance of the database, and can introduce onerous compute overhead. More effective techniques for scanning an identifying sensitive data are needed by database administrators (DBAs) and entities associated with large data repositories that are subject to regular or even intermittent scans for sensitive data.

### BRIEF SUMMARY

According to one aspect of the present disclosure, a first location in memory is identified. The first location in memory contains first data rows copied from a second location in the memory containing second data rows retrieved from one or more objects in a data repository. A portion of the first data rows to be scanned is selected, where the portion of the first data rows corresponds to a first object of the one or more objects. A scan of the portion of the first data rows is performed and a probability that the first object contains sensitive data is calculated. The probability is calculated based, at least in part, on one or more instances of sensitive data identified during the scan. The first object in the data repository is marked with a sensitive data indicator, and the sensitive data indicator based, at least in part, on the probability that the first object contains sensitive data.

### BRIEF DESCRIPTION OF THE DRAWINGS

FIG. 1 is a simplified block diagram of an example of some components of a communication system for opportunistic data content discovery scans of a data repository, according to at least one embodiment of the present disclosure.

FIG. 2 is a simplified block diagram illustrating additional details of certain components of the communication system according to at least one embodiment.

FIG. 3 is a simplified block diagram illustrating example data and operation flow of the communication system according to at least one embodiment.

FIGS. 4A-4C are block diagrams illustrating an example scenario of the communication system in which opportunistic data content discovery scans are performed according to at least one embodiment.

FIG. 5 is a simplified flow diagram related to a data utility process according to at least one embodiment.

FIG. 6 is a simplified flowchart of possible operations related to the communication system according to at least one embodiment.

FIG. 7 is a simplified flowchart of possible operations related to a data content discovery process according to at least one embodiment.

FIGS. 8A-8B are simplified flowcharts of possible operations related to scoring and marking data discovered in a data content discovery scan according to at least one embodiment.

FIG. 9 is a simplified flowchart of possible operations related to data content discovery scans based on scores according to at least one embodiment.

FIG. 10 is a simplified flowchart of possible operations related to data content discovery scans based on object naming conventions according to at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” “manager,” “agent,” “element,” “algorithm,” “scan,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium include the following: a mass storage device (MSD), a Universal Serial Bus (USB) flash drive, a portable computer diskette, a hard disk, a random access memory (RAM), a read-only memory (ROM), a programmable read-only memory (PROM), an erasable programmable read-only memory (EPROM or Flash memory), an electrically erasable read only memory (EEPROM), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, low-level programming languages such as assembly languages, conventional procedural programming languages, such as the “C” programming language, Visual Basic, Fortran 2003, Perl, COBOL 2002, PHP, ABAP, assembly language, dynamic or script programming languages such as Python, Ruby and Groovy, batch file (.BAT or .CMD), powershell file, REXX, or any format of data that can describe sequences (e.g., XML, JSON, YAML, etc.), or other programming languages. By way of example, the program code may execute entirely on a mainframe system, entirely on a database server, partly on a mainframe system or database server and partly on a remote computer, or entirely on a remote computer. In the scenarios involving a remote computer, the remote computer (e.g., server) may be connected to a mainframe system and/or database server through any type of network, including a local area network (LAN) or a wide area network (WAN), or the connection may be made through an external computer (for example, through the Internet using an Internet Service Provider) or in a cloud computing environment or offered as a service such as a Software as a Service (SaaS). Generally, any combination of one or more local computers and/or one or more remote computers may be utilized for executing the program code.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses, or other devices to produce a computer implemented process such that the instructions, which execute on the computer, other programmable apparatuses, or other devices, provide processes for implementing the functions/acts specified in the flowchart and/or block diagram block or blocks.

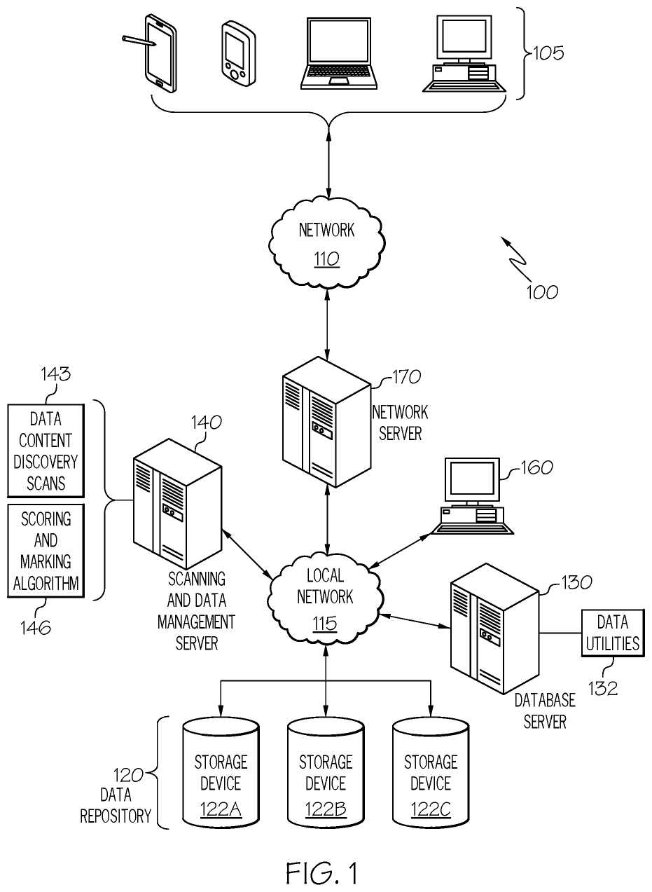

Referring now to FIG. 1, a simplified block diagram is shown illustrating an example communication system 100 for opportunistic data content discovery scans of a data repository according to at least one embodiment. In communication system 100, a network 110 (e.g., a wide area network such as the Internet) facilitates communication between user devices 105 and a network server 170. Network server 170 may be configured to communicate with one or more of a database server 130, a scanning and data management server 140, a data repository 120, and a user terminal 160. In one implementation, such communication may be provided via a local network 115. Network server 170 may be configured to enable access from user devices 105 to database server 130 and data repository 120, which can include one or more data storage devices, such as data storage devices 122A, 122B, and 122C. User devices 105 can enable users to interface with database server 130 and to consume data contained in data repository 120. User terminal 160 may be used to enable an authorized user, such as a Database Administrator (DBA), to communicate with and issue commands to database server 130 to access the data repository. In other embodiments, user terminal 160 could be directly connected to database server 130 or could be remotely connected to database server 130 over the Internet, for example.

Database server 130 may include one or more data utilities 132 that read data from data repository 120 to perform various actions on the data repository such as, for example, data copy/backup, data load, data unload, and/or data reorganization. Scanning and data management server 140 may include data content discovery scans 143 and scoring and marking algorithms 146 for scanning and scoring data that is read by data utilities 132. Also, although storage devices 122A-C are shown as separate storage devices communicating with database server 130 via local network 115, it should be apparent that one or more of these storage devices may be combined in any suitable arrangement and that any of the storages devices 122A-C may be connected to database server 130 directly or via some other network (e.g., wide area network, direct connection, etc.). Moreover, one or more of the components shown in FIG. 1 may be provided in a mainframe system in at least some implementations.

For purposes of illustrating certain example techniques of communication system 100 for opportunistically scanning and scoring data from a data repository (e.g., 120), it is important to understand the activities that may be occurring in a network environment that includes a data repository configured with data structures capable of hosting large quantities of data. The following foundational information may be viewed as a basis from which the present disclosure may be properly explained.

Data structures are used by storage devices (e.g., MSDs, DASDs) to store massive amounts of data across virtually every sector of society including, but not limited to, social media, business, retail, health, education, and government. A database generally refers to a collection of information organized in data structures such that the data can be easily accessed, managed, and updated. Although the concepts presented herein are applicable to any type of data structures used in storage devices, most of the world's data is stored in data structures of a database. Therefore, the discussion herein may reference databases for ease of illustration; however, it should be understood that the concepts are also applicable to other types of data structures that are separate from databases.

A typical database may include multiple objects. As used herein, an ‘object’ is intended to include any data structure (or format) for organizing, managing, and storing data to enable access and modification of the data. Examples of objects include, but are not necessarily limited to tables, indexes, tablespaces, and index spaces. A tablespace can be embodied as a file containing raw data, some of which can be application data and some of which can be used internally to help manage the data. Logical data columns can be arranged in logical data rows within a tablespace. These logical data columns are stored as a logical data table. In some implementations, a logical data table (also referred to herein as ‘table’) may be viewable and potentially modifiable by a user online.

Tablespaces can have various configurations and characteristics. For example, one type of tablespace may be segmented and may store a different table in each segment. Another type of tablespace may be partitioned and store a single table. Yet another type of tablespace can use a combination of partitioned and segmented tablespace schemes. Other types of tablespaces may be partitioned for extended addressability (EA), configured to hold large object data, configured to store an XML table, or configured as a simple tablespace that is neither partitioned nor segmented. Certain information may be extracted by database utility processes that access a tablespace. For example, extracted information can include a name of the tablespace and characteristics of the tablespace including, but not necessarily limited to, page size, record identifier (RID) length, partition size, segment size, maximum partitions, maximum rows, type of tablespace (e.g., partitioned, segmented, combination, etc.). By way of illustration, an example name of a tablespace could be R102G01.S102G01.

Like a tablespace, an index space can also be embodied as a file containing raw data. An index space, however, may be defined for a particular data table. Moreover, in at least one implementation, an index space may contain a single index for a single data table. One or more selected logical data columns from the data table may be arranged in a desired order in logical data rows within an index space. These logical data columns within the index space may be stored as a logical index (also referred to herein as ‘index’) and contain the data from those columns in the data table. The index can also include pointers to rows in the data table. Various different types of indexes may be created. For example, a unique index may ensure that the value in a particular column or set of columns is unique, a primary index may be a unique index on the primary key of the table, a secondary index may be an index that is not the primary index, a clustering index may ensure a logical grouping, and an expression-based index may be based on a general expression. Other index types may be applicable to particular types of tables (e.g., partitioned tables, XML tables, etc.).

A database may also maintain a catalog of information about the data stored in the database. In at least some examples, this catalog of information may be implemented as a set of tables in the database. Catalog tables may contain information about database objects including tables, indexes, tablespaces, and index spaces. In one example, a catalog table may contain information about objects that are of the same type. Each row of the catalog table contains information about a different object of that type. This information can describe the structure of the object and tell how the object relates to other objects, including different types of objects.

In an example database containing tables, indexes, tablespaces and index spaces, a first catalog table may contain information about tables, a second catalog table may contain information about tablespaces, a third catalog table may contain information about indexes, and a fourth catalog table may contain information about index spaces. For example, in a catalog table containing information about tables, a row in the catalog table may correspond to a particular table in the database and include a name of the table, a name of the table's tablespace, a name of the table's database, etc. In a catalog table containing information about tablespaces, a row in the catalog table may correspond to a particular tablespace in the database and include a name of the tablespace, a name of the tablespace's database, a number of tables defined in the tablespace, the type of the tablespace, etc. In a catalog table containing information about indexes, a row in the catalog table may correspond to a particular index in the database and include a name of the index, a name of the table on which the index is defined, a number of columns in the key of the index, a name of the index's database, etc.

When an object in a database is created, modified, or deleted, the appropriate row in the appropriate catalog table can be added, updated, or deleted, respectively. For example, if a new table A is added to a database, a row may be added to a catalog table for tables. The added row can contain the name of table A, the name of table A's tablespace, and the name of table A's database, among other information. In another example, if a tablespace B in a database is modified, a row that contains information related to tablespace B in a catalog table for tablespaces may be updated to reflect the modifications to tablespace B. In yet another example, if index C is deleted from a database, then a row containing information related to index C may be deleted from a catalog table for indexes.

Databases are used by a multitude of entities to store information related to their specific activities. Depending on the entity, such activities may be related to business, government, education, healthcare, banking and finance, transportation, or any other service, scheme, or enterprise that engages in information gathering or collection. Databases are common in large mainframe systems as well as smaller distributed and midrange systems. Some databases can hold massive amounts of information. For example, sales transactions, product catalogs and inventories, customer profiles, patient records, and the like may result in the aggregation of millions of data records in databases storing such information.

The amount of sensitive data that is collected and stored by various entities such as government organizations and businesses, as well as the risks associated with the collected and stored sensitive data has increased exponentially in recent years. Generally, ‘sensitive data’ as used herein is intended to mean any information that is intended to be kept secret and/or to be protected from disclosure to unauthorized individuals and entities. One example of sensitive data can be referred to as personally identifiable information (PII) or sensitive personal information (SPI). PII or SPI can include any information that can be used on its own or in combination with other information to identify, contact, or locate an individual. Other sensitive data can include financial information such as bank accounts, credit card numbers, financial account numbers, etc. Another example of sensitive data can include patient or health record information. These non-limiting examples of sensitive data are for illustration purposes, and it should be apparent that numerous different types of information may be deemed as sensitive data and that data security may be applied to prevent the unauthorized disclosure of these other types of sensitive information including both malicious and unintentional disclosures that are unauthorized.

Privacy and security laws and regulations have evolved to address the risks associated with the increasing amounts of sensitive data that is collected and stored by various entities such as government organizations and businesses. Entities with large (and even midrange and small) databases typically perform various scans to identify sensitive data that is stored in the databases. In one example, a scanning and data management utility known as Data Content Discovery (DCD), offered by CA Technologies of New York, N.Y., can allow security and compliance events and issues to be identified in mainframe data. DCD manages data and addresses security and compliance needs. DCD further provides security and compliance with enriched event reporting and support for data-in-motion that prevents loss of sensitive data on the mainframe.

A scanning and data management utility, such as DCD, can identify sensitive data by searching data streams and stored data within a system to identify sensitive data based on pre-specified data. A scan can identify instances of sensitive data or other data for which rules have been defined to identify content of interest (e.g., sensitive data). In particular, scans often use expressions that represent particular patterns of commonly stored sensitive data. For example, an expression to detect a social security number may be in the form of NNN-NN-NNN with ‘N’ representing any number from 0-9. In another example, an expression to detect a credit card number may be in the form of NNNN NNNN NNNN NNNN. In yet another example expression, a driver's license may be detected using the form of DDDDDDDD, where ‘D’ represents an alphanumeric character (e.g., numbers 0-9 and letters A-Z). Some expressions may represent particular terms or specific words such as “Confidential” or “Attorney Client Privileged”, for example.

Scans that search for sensitive data are often performed on top of databases. For example, database files in the mainframe are scanned by accessing the files directly. This can introduce additional data reads of the database, which are expensive and can hinder overall performance of the database. The additional reads can also introduce onerous compute overhead. In some scenarios, database records can be locked down and further reads may be prevented. Additionally, for databases that offer near-continuous access, frequent additions and updates to the data records can necessitate regular scans to identify newly added or changed sensitive data within the database.

A communication system, such as communication system 100 for performing opportunistic data content discovery scans of a data repository, as outlined in the FIGURES, can resolve these issues and others. This system leverages existing transactions, such as data utilities that are used to manage a data repository (e.g., a database) and that require reads of data in the data repository to perform the transaction. A data utility can be leveraged to opportunistically enable a scan of data that is read into memory from the data repository by the data utility performing its normal function. When a data utility reads data from a data repository into memory, embodiments herein cause the read data in memory to be copied to another location in the memory. Once the read data is copied to the new location in memory, an opportunistic discovery scan can be used to scan the copied data. Based on the results of the scan or scans, certain objects of the data repository may be scored to indicate a probability of that object containing sensitive data. For example, tables, tablespaces, indexes, and/or index spaces may be scored. In some scenarios, an object may be marked (e.g., with a flag bit) to indicate the definite presence or absence of sensitive data in that object.

Marked objects in a data repository may also be used for subsequent scanning to target specific objects and/or locations in a data repository. In one embodiment, objects marked with a score indicating a probability that exceeds a certain threshold may be scanned again to ensure that the entire object has been scanned. The objects to be scanned again may be scanned in order from the highest probability to the lowest probability. In another embodiment, an object marked with a score exceeding a certain threshold or marked with an indication that the object contains sensitive data may be examined to determine the naming convention used for an identifier (or name) of the object. The data repository may be searched for other objects having identifiers (or names) with a threshold level of similarity to the identifier (or name) of the object having the score or indication of sensitive data.

Embodiments of a system for performing opportunistic data content discovery scans of a data repository can offer several advantages. Data content discovery scans can be performed on a data repository without having to introduce additional reads on the data repository. This can reduce the expense of security and compliance for the data repository and prevent performance degradation or possible downtime of the data repository due to read accesses to perform scanning. An opportunistic scan as disclosed in the embodiments herein, relative to a database read, introduces a significantly less amount of additional latency and overhead. Additionally, for large data repositories, reading the entire data repository can consume significant resources and time. By marking objects in a data repository with sensitive data indicators such as probability scores and flags indicating the presence of sensitive data, scans can be targeted to follow a path through the data repository in which particular objects of the data repository are scanned based on objects that have the highest probability of containing sensitive data to objects having the lowest probability of containing sensitive data.

Turning to FIG. 1, a brief description of the infrastructure of communication system 100 is now provided. Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs.

Generally, communication system 100 can be implemented in any type or topology of networks. Within the context of the disclosure, networks such as networks 110 and 115 represent a series of points or nodes of interconnected communication paths for receiving and transmitting packets of information that propagate through communication system 100. These networks offer communicative interfaces between sources, destinations, and intermediate nodes, and may include any local area network (LAN), virtual local area network (VLAN), wide area network (WAN) such as the Internet, wireless local area network (WLAN), metropolitan area network (MAN), Intranet, Extranet, virtual private network (VPN), and/or any other appropriate architecture or system that facilitates communications in a network environment or any suitable combination thereof. Networks 110 and 115 can use any suitable technologies for communication including wireless (e.g., 3G/4G/5G/nG network, WiFi, Institute of Electrical and Electronics Engineers (IEEE) Std 802.11™-2012, published Mar. 29, 2012, WiMax, IEEE Std 802.16™-2012, published Aug. 17, 2012, Radio-frequency Identification (RFID), Near Field Communication (NFC), Bluetooth™, etc.) and/or wired (e.g., Ethernet, etc.) communication. Generally, any suitable means of communication may be used such as electric, sound, light, infrared, and/or radio (e.g., WiFi, Bluetooth, NFC, etc.). Suitable interfaces and infrastructure may be provided to enable communication within the networks.

In general, “servers,” “clients,” “computing devices,” “storage devices,” “network elements,” “database systems,” “data repositories,” “network servers,” “user devices,” “user terminals,” “systems,” etc. (e.g., 105, 120, 130, 140, 160, 170, etc.) in example communication system 100, can include electronic computing devices operable to receive, transmit, process, store, or manage data and information associated with communication system 100. As used in this document, the term “computer,” “processor,” “processor device,” or “processing device,” is intended to encompass any suitable processing device. For example, elements shown as single devices within communication system 100 may be implemented using a plurality of computing devices and processors, such as server pools including multiple server computers. In some embodiments, one or more of the elements shown in FIG. 1 may be combined to form a mainframe system. Further, any, all, or some of the computing devices may be adapted to execute any operating system, including IBM zOS, Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, computing devices, storage devices, network elements, database systems, network servers, user devices, user terminals, systems, etc. (e.g., 105, 120, 130, 140, 160, 170, etc.) can each include one or more processors, computer-readable memory, and one or more interfaces, among other features and hardware. Servers can include any suitable software component, manager, controller, or module, or computing device(s) capable of hosting and/or serving software applications and/or services, including distributed, enterprise, or cloud-based software applications, data, and services. For instance, in some implementations, database server 130, scanning and data management server 140, storage devices 122A-122C of data repository 120, and network server 170, or other sub-system of communication system 100, can be at least partially (or wholly) cloud-implemented, web-based, or distributed to remotely host, serve, or otherwise manage data, software services and applications interfacing, coordinating with, dependent on, or used by other services, devices, and users (e.g., via network user terminals, other user terminals, etc.) in communication system 100. In some instances, a server, system, subsystem, or computing device can be implemented as some combination of devices that can be hosted on a common mainframe system, computing system, server, server pool, or cloud computing environment and share computing resources, including shared memory, processors, and interfaces.

While FIG. 1 is described as containing or being associated with a plurality of elements, not all elements illustrated within communication system 100 of FIG. 1 may be utilized in each alternative implementation of the present disclosure. Additionally, one or more of the elements described in connection with the examples of FIG. 1 may be located external to communication system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein

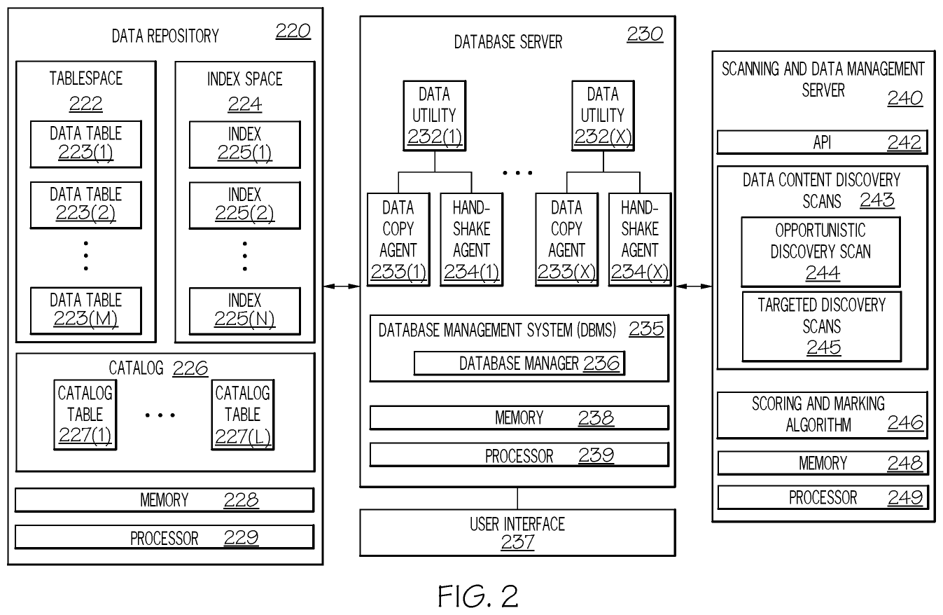

FIG. 2 is a simplified block diagram that illustrates additional possible details that may be associated with certain components of communication system 100. Specifically, a database server 230 is one possible example of database server 130, a scanning and data management server 240 is one possible example of scanning and data management server 140, and a data repository 220 is one possible example of data repository 120. The elements of FIG. 2 are representative of possible components involved in opportunistic data content discovery scans of a data repository.

Data repository 220 may include a tablespace 222, an index space 224, and a catalog 226. Tablespace may include one or more data tables 223(1)-223(M). As previously described herein, the number of data tables included in a single tablespace, such as tablespace 222, may vary at least in part based on the type of tablespace that is configured. Index space 224 may include one or more indexes 225(1)-225(N), and each index can be associated with a single data table. In some embodiments, each index space contains only one index. It should be noted that FIG. 2 is a simplified block diagram for illustrative purposes, and that a data repository, such as data repository 220, may include any number of tablespaces and indexes.

Data repository may also include a catalog 226, with one or more catalog tables 227(1)-227(L). Catalog tables may contain information about objects (e.g., tablespace 222, data tables 223(1)-223(M), index spaces 224, indexes 225(1)-255(N)) in data repository 220 and each catalog may be specific to a particular type of object in at least one embodiment. For example, one catalog table may be associated with data tables and each row may contain information related to a particular data table. Another catalog table may be associated with tablespaces and each row may contain information related to a particular tablespace. Yet another catalog may be associated with indexes and each row may contain information related to a particular index. In some embodiments, a catalog table may be associated with index spaces and each row may contain information related to a particular index space. Data repository 220 may also include appropriate hardware, including, but not necessarily limited to a memory 228 and a processor 229.

Database server 230 may include a database management system (DBMS) 235, which creates and manages databases, including providing data utilities (e.g., batch utilities), tools, and programs. A database manager 236 can create a database processing region (also referred to as a multi-user facility (MUF)) where user processing and most utility processes flow. One or more data utilities 232(1)-232(X) may be run by database manager 236 to perform various functions on data repository 220. For example, one data utility could be copy utility that reads data from data repository 220 and creates a backup copy. A second data utility could be a load utility that loads data into in data tables 223(1)-223(M) or indexes 225(1)-225(N) of data repository 220. A third data utility could be an unload utility that unloads data from data tables 223(1)-223(M) or indexes 225(1)-225(N) of data repository 220. A fourth data utility could be a reorganization utility that reorganizes a database by unloading (e.g., reading) data from one or more areas of data repository 220 and then loading (e.g., storing) the reorganized data into one or more areas of another database or the same database. In accordance with one or more embodiments, each data utility could include a data copy agent (e.g., 233(1)-233(X)) and a handshake agent 234(1)-234(X)).

When executing, each one of data utilities 232(1)-232(X), reads all or part of the data from data repository 220 into memory. For example, a copy utility that backs up the data in the database may read all of the data from the database (e.g., all data tables in all tablespaces, all indexes in all index spaces, etc.) into memory. An unload utility may read all of the data into memory or may read certain portions of the data into memory. For example, particular data tables or particular records in a data table or data tables may be read into memory by an unload utility depending on selected parameters or criteria controlling the unload utility when it runs. In another example, a reorganization utility may read an entire tablespace into memory during the reorganization process but may not reorganize every tablespace associated with the database during the same reorganization process.

In one or more embodiments disclosed herein, once a data utility reads data from a data repository into one location in memory, a data copy agent (e.g., 233(1)-233(X)) can copy the data from the one location in memory to another (second) location in memory. A handshake agent (e.g., 234(1)-234(X)) can subsequently communicate to scanning and data management server 240 to provide information needed by scanning and data management server 240 to perform data content discovery scans of the copied data. For example, the handshake agent may notify scanning and data management server 240 regarding which data utility has copied data into a second location in memory. The handshake agent may also provide other information including, but not necessarily limited to, a memory address indicating the location in memory of the copied data, an identifier (or name) of each object with at least some data copied to the second location memory, and a number of the data rows copied to the second location in memory for each object.

At least some of the information passed by the handshake utility to the scanning and data management server could be obtained from a table of statistics maintained for the database. In one example, the table of statistics can maintain statistics related to each object (e.g., number of rows read into memory, number of total rows in the object, etc.). Other information passed by the handshake utility to the scanning and data management server could be obtained from a catalog table or tables containing information related to the object or objects for which information is being communicated to the scanning and data management server.

In at least one embodiment, each data utility 232(1)-232(X) may be modified to include a data copy agent, such as data copy agents 233(1)-233(X) and a handshake agent, such as handshake agents 234(1)-234(X). In other embodiments, it may be possible to implement one or both of a data copy agent and a handshake agent separate from the respective data utilities. A data copy agent (e.g., 233(1)) could receive information from its associated data utility (e.g., 232(1)), such as the location in memory into which the data utility (e.g., 232(1)) read data from the database. The data copy agent could then initiate the handshake agent to communicate with scanning and data management server (e.g., 240) to provide information that enables one or more opportunistic data content scans to be run against the copied data. In further embodiments, where a common read function is utilized by the data utilities 232(1)-232(X), a single data copy agent and handshake agent could be implemented to copy data that has been read into memory at a first location by one of the data utilities to a second location in the memory. The handshake agent could then provide relevant information to the scanning and data management server.

Database server 230 may also include hardware including, but not limited to, a memory 238 and a processor 239. In some implementations, a user interface 237 may also be coupled to database server 230. User interface could include any suitable hardware (e.g., display screen, input devices such as a keyboard, mouse, trackball, touch, etc.) and corresponding software to enable an authorized user (e.g., Database Administrator (DBA)) to communicate directly with database server 230. For example, in some scenarios, a DBA may configure data utilities 232(1)-232(X) to initiate their respective data copy agents and handshake agents.

Scanning and data management server 240 can include an application programming interface (API) 242, data content discovery scans 243, a scoring and marking algorithm 246, and appropriate hardware including, but not limited to, a memory 248 and a processor 249. API 242 may be used by the data content discovery scans 243 to access data in memory of the database server. For example, data that has been read into memory at a first location by a data utility (e.g., 232(1)-232(X)) and then copied from the first location to a second location in the memory may be accessed by API 242 to enable scanning algorithms to scan the stored data.

Data content discovery scans 243 may include an opportunistic discovery scan 244 and one or more targeted discovery scans 245 in at least one embodiment. In some implementations, data extracted from a data repository may lose some of its metadata that explains what is present in the data. Accordingly, data content discovery scans 243 may attempt to recover the hidden structure of the data before the data is scanned for sensitive data.

Opportunistic discovery scan 244 may perform scanning of data copied into a second location in memory to identify sensitive data. Various rules may be defined to identify content of interest and those rules can be applied during the scanning. For example, regular expressions representing patterns of certain common types of information that corresponds to sensitive data such as PII or SPI may be used to find pieces of information in the stored data that looks like the regular expression. In one implementation, an expression may be compared to successive strings of character representations (e.g., bytes) in the stored data to determine whether a match is present. Expressions can include, for example, patterns for social security numbers, credit card numbers, drivers' licenses, passport numbers, phone number, etc. Explicit expressions may include particular words, number strings, alphanumeric strings, etc. may be compared to successive strings of character representations. For example, “privileged”, “attorney-client”, and “confidential” may be used to identify certain types of confidential legal data in the database.

In at least one embodiment, the copied data may be scanned and evaluated per object. Opportunistic discovery scan 244 may receive the number of data rows copied into the second location in memory for each object. For example, if data table 223(1) contains 20,000 data rows, but only 5000 data rows of data table 223(1) are read into memory and then copied to a second location, handshake agent 234(1) can provide information to scanning and data management server 240 indicating the identifier of the object and the number of data rows (i.e., 5000) that were copied into the second location of memory. Opportunistic discovery scan 244 can query real-time statistics for data tables to discover the total number of data rows (i.e., 20,000) contained in data table 223(1) in the data repository. Opportunistic discovery scan 244 can scan the 5000 data rows stored in the second location in memory and calculate the percentage of the data table 223(1) that is scanned (i.e., 25% or 0.25).

Opportunistic discovery scan 244 may generate a scan output with information related to the scan. In at least one embodiment, the information in the scan output can be provided per object scanned. For each object having data rows that are scanned, the scan output could include an identifier of the object, a quantity of matches to expressions found in the object, a percentage of the object that was scanned. The scan output can be provided to, or otherwise accessed by, scoring and marking algorithm 246. In at least one embodiment, scoring and marking algorithm 246 consumes the scan output from the opportunistic discovery scan 244. Based at least in part on the scan output, in at least some scenarios, scoring and marking algorithm 246 can determine that an object contains sensitive data or that the object does not contain sensitive data. In other scenarios, scoring and marking algorithm 246 can determine a score that represents the probability that a particular object contains sensitive data. In both scenarios, the object can be marked to indicate the determination that it contains sensitive data, that it does not contain sensitive data, or that there is a particular probability that it contains sensitive data.

Based at least in part on the scan output, in at least some scenarios, scoring and marking algorithm 246 can determine that an object contains sensitive data or that the object does not contain sensitive data. The determination may be made based on the percentage of the object that was scanned (e.g., the percentage of data rows in the object that were read into memory and copied to a second location in the memory) and an amount of sensitive data that was identified during the scan of the object data stored in the second location in the memory. For example, if the entire object was scanned, and the amount of sensitive data identified during the scan exceeds an upper threshold, then a determination may be made that the object does contain sensitive data and the object may be marked accordingly. If the entire object was scanned but the amount of sensitive data identified during the scan does not exceed a lower threshold, then a determination may be made that the object does not contain sensitive data. In some implementations, if only a portion of the object is scanned, then the object may not be evaluated for definitive determinations as to whether the object contains or does not contain sensitive data. In other implementations, the object may be evaluated for definitive determinations as to whether the object contains or does not contain sensitive data based on a threshold amount of the object being scanned. In this implementation, the upper and lower thresholds may be higher and lower, respectively. In yet another example, a definitive determination that an object contains sensitive data may be made based on identifying an explicit expression in the copied data rows (e.g., “Attorney-Client Privileged”).

If a determination is made that an object contains sensitive data, then the object may be marked to indicate that a determination has been made that the object contains sensitive data. If a determination is made that an object does not contain sensitive data, then the object may be marked to indicate that a determination has been made that the object does not contain sensitive data. In at least one embodiment, a flag that can have one of two values may be used to mark an object to indicate that either the object contains sensitive data, or the object does not contain sensitive data. For example, if the flag is embodied as a bit, it may be set to ‘1’ if the object contains sensitive data. If the object does not contain sensitive data, then the bit may be set to ‘0’. In some implementations, the flag may be configured to store a third value indicating a null value (e.g., when a definitive determination cannot or has not been made). Accordingly, the flag could be implemented using a single bit, a byte, or any suitable number of bits or bytes based on particular needs and implementations.

In at least some scenarios, scoring and marking algorithm 246 may calculate a score that represents a probability that an object contains sensitive data and then mark the object with the score. The calculation may be based, at least in part, on the scan output. A score may be calculated based on the percentage of the object that was stored in the second location in memory and scanned to identify sensitive data and the amount of sensitive data that was identified during the scan. For example, if a data utility reads 60% of an object into memory and only a few instances of sensitive data are identified during the scan of the copied data, then the score may reflect a low probability that the object contains sensitive data. In another example, if only 5% of an object is read into memory by a data utility, and numerous instances of sensitive data are identified during the scan of the copied data, then the score may reflect a high probability that the object contains sensitive data. Scores may be calculated for any object, such as a data table, a tablespace that includes one or more data tables, an index, or an index space that includes one or more indexes. Once a score has been calculated, then the object may be marked with the score to indicate the probability that the object contains sensitive data.

Flags and scores are types of sensitive data indicators that may be used to mark objects in a data repository to indicate that an object contains sensitive data, to indicate an object does not contain sensitive data, or to indicate a probability that an object contains sensitive data. In at least one example, catalogs in, or associated with, the data repository may be used to mark objects in the data repository with flags and/or scores. In at least one embodiment, a catalog may be associated with a certain type of objects (e.g., data tables, tablespaces, indexes, or index spaces) and may contain a data row for each object having the same type. For example, in a catalog associated with tablespaces, each data row corresponds to a respective tablespace and contains information about the respective tablespace. The catalog may be configured to include a column for a flag and/or a column for a score. Accordingly, a score column and a flag column in a data row corresponding to a particular tablespace may be updated with appropriate values based on the determinations that are made for the particular tablespace. If a determination is made that the tablespace contains sensitive data, then the flag column may be set to ‘1’ and the score column may be null or zeros. If a determination is made that the tablespace does not contain sensitive data, then the flag column may be set to ‘0’ and the score column may be null or zeros. If a determination is made that the tablespace has a 50% probability of containing sensitive data, then the score column may be updated to reflect 50% (e.g., 0.50) and the flag column may contain a null value.

If a tablespace contains a single data table, then a flag marked for the data table and/or a score marked for the data table can also be marked for the tablespace. Similarly, if an index space contains a single index, then a flag marked for the index and/or a score marked for the index can also be marked for the index space. In some embodiments, when a tablespace contains a single data table, only one of the tablespace or data table may be marked with a flag and/or score. In some embodiments, when an index space contains a single index, only one of the index space or index may be marked with a flag and/or score.

If a tablespace contains multiple data tables, then any appropriate scoring may be implemented to determine flag and score markings for the tablespace. In one example, if a flag is set for any data table in a tablespace, then a flag is also set for the tablespace. If a flag is not set for any of the data tables within the tablespace, then the highest score of the data tables may also be used to mark the tablespace. Similarly, if a flag is set for any index in an index space, then a flag is also set for the index space. If a flag is not set for any of the indexes within the index space, then the highest score of the indexes may also be used to mark the index space.

Data content discovery scans 243 may also include targeted discovery scans 245 that utilize marked objects in a data repository to target their scans for sensitive data. In a first example of targeted discovery scans, catalogs of a data repository may be examined to find which objects are marked with scores indicating the highest probability of containing sensitive data. The objects may be scanned from highest probability to lowest probability in at least one embodiment. Because the scores can be calculated based on a portion of the data rows of an object, an object may be rescanned in its entirety to determine whether the object contains sensitive data based on the contents of all of the data rows in the object, rather than just a portion. Rescanning an object marked with a high score is more likely to result in finding additional sensitive data in the object. Thus, targeted discovery scans 245 may perform rescanning more efficiently and effectively by rescanning certain objects based on the scores associated with the objects.

In a second example of targeted discovery scans 245, the naming convention used in an object may be leveraged to find sensitive data in other parts of the data repository using a similar naming convention. In this example, catalogs of a data repository may be examined to find an object marked with a flag indicating the object contains sensitive data. When a particular object is determined to have its flag set, the naming convention of the identifier of the particular object is evaluated. The catalog associated with the particular object may be searched for another object having an identifier with a threshold level of similarity to the identifier of the particular object. If another object is found based on its identifier, then it may be scanned for sensitive data and marked accordingly.

Catalogs of the data repository may also be examined to find an object with a score indicating the highest probability that the object contains sensitive data. When a particular object is determined to have the highest probability of containing sensitive data in a data repository, the naming convention of the identifier of the particular object is evaluated. The catalog associated with the particular object may be searched for another object having an identifier with a threshold level of similarity to the identifier of the particular object. If another object is found based on its identifier, then it may be scanned for sensitive data and marked accordingly. Additional objects may be identified based on a highest to lowest probability that the objects contain sensitive data. The identifiers of these additional objects may be used in the same or similar manner to identify other objects having identifiers with similar naming conventions.

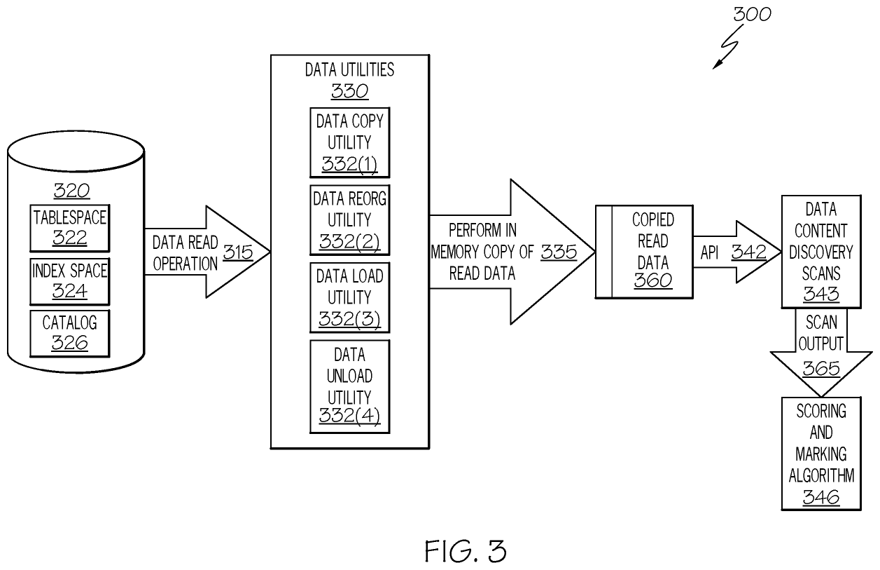

Turning to FIG. 3, a simplified block diagram illustrates an example of data and operation flow 300 of a communication system for opportunistic data content discovery scans of a data repository according to at least one embodiment. In the data and operation flow 300, several elements are examples of elements of a communication system such as communication system 100. Specifically, a data repository 320 contains a tablespace 322, an index space 324, and a catalog 326 and is one possible example of data repository 120, 220, data utilities 332(1)-332(4) are possible examples of data utilities 132, 232(1)-232(X), API 342 is one possible example of API 242, data content discovery scans 343 are possible examples of data content discovery scans 143, 243 and scoring and marking algorithm 346 is a possible example of scoring and marking algorithm 146, 246.

In a communication system for opportunistically performing data content discovery scans of a data repository, such as communication system 100, a data read operation is performed at 315 on data repository 320 by one of data utilities 330. Any one of several data utilities may perform the data read operation, such as a data copy utility 332(1), a data reorg utility 332(2), a data load utility 332(3), or a data unload utility 332(4). Data copy utility 332(1) may read data from tablespace 322 and/or index space 324 of data repository 320 and creates a backup copy. Data reorg utility 332(2) can reorganize a database by unloading (e.g., reading) data from one or more areas of data repository 320 and then loading (e.g., storing) the reorganized data into one or more areas of another data repository or the same data repository. Data load utility 332(3) can load data into data table(s) in tablespace 322 and/or into index(es) in index space 324 of data repository 320. Data unload utility can unload data from data table(s) in tablespace 322 and/or index space 324 of data repository 220 into files, other data tables, other tablespaces, other index spaces, or other data repositories, for example.

Once the data utility reads data from data repository 320 into memory, at 335, an in-memory copy of the read data is performed. In at least one embodiment, the data utility that read the data into memory performs the in-memory copy (e.g., data copy agent 233(1)-233(X)) to store a copy of the read data in another location in memory (also referred to herein as ‘second location’). The copied data that is stored in the second location in memory is shown as copied read data 360 in FIG. 3. In other embodiments, the in-memory copy may be performed by a separate agent that may be initiated or triggered by the data utility. The in-memory copy may be an assembler program in at least one embodiment. The data utility can record an identifier of the tablespace that has been copied. In addition, the data utility may also record identifiers of particular tables within the tablespace that have been copied. This information can be provided to data content discovery scans 343.

Data content discovery scans 343 may use API 342 to scan the copied read data 360 to identify sensitive data. Data content discovery scans 343 may generate a scan output 365 that includes information related to the scan. The information in the scan output may include information related to the scan of particular objects in the copied read data 360, such as a quantity of sensitive data or possibly sensitive data found in the object, a type of matched expressions found in the object, a name/identifier of the object, a calculated percentage of object that was scanned. Scan output 365 may be used by scoring and marking algorithm 346 to determine a score or flag to be marked on objects in the data repository based on the scan results of those objects that is provided in the scan output 365.

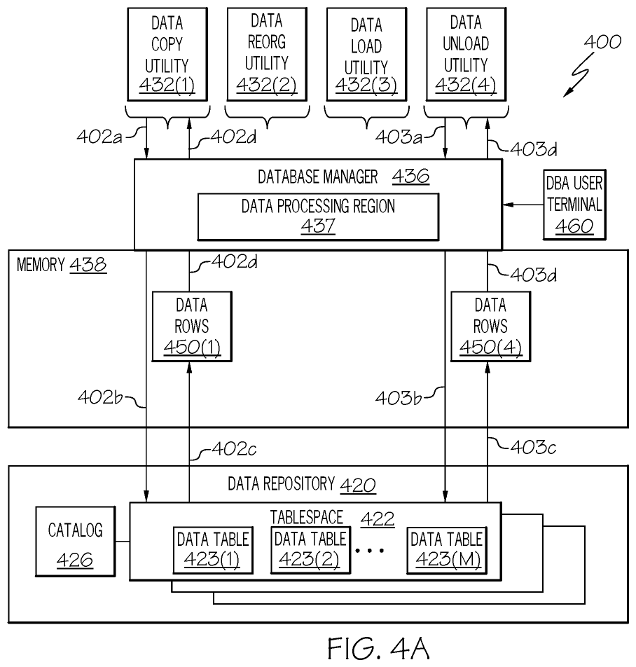

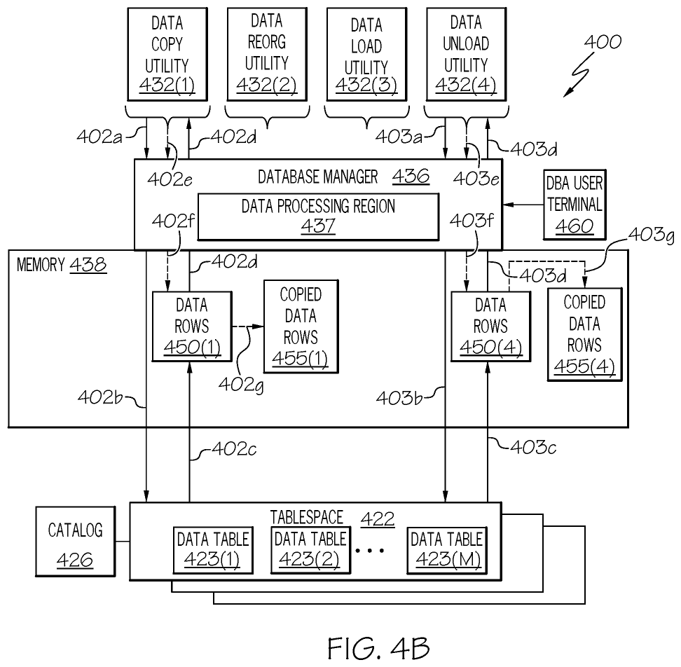

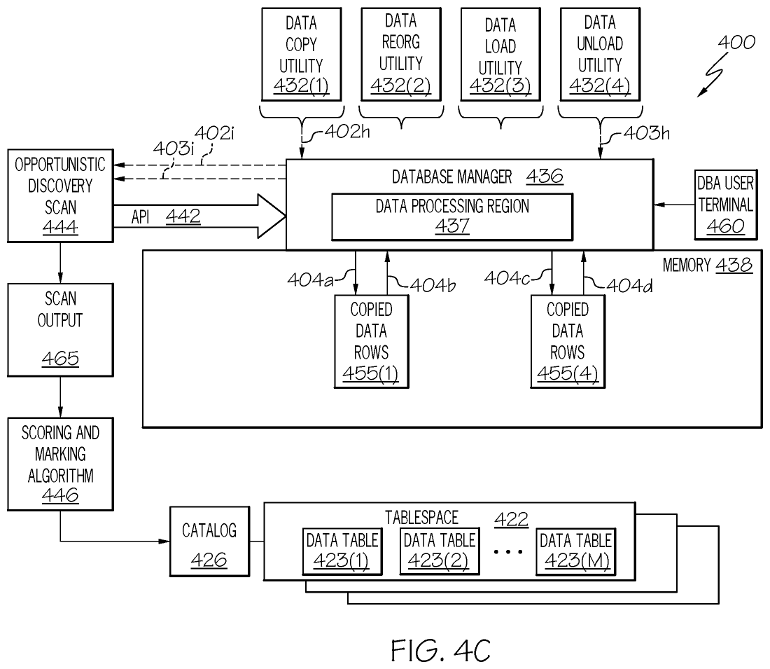

Turning to FIGS. 4A-4C, block diagrams illustrate an example scenario of a database environment in a communication system in which one or more opportunistic data content discovery scans of a data repository are performed. A database environment 400 includes a database manager 436 with a data processing region 437, a memory 438, a data copy utility 432(1), a data reorg utility 432(2), a data load utility 432(3), a data unload utility 432(4), a DBA user terminal 460, a data repository 420 with a catalog 426 and a tablespace 422 that contains data tables 423(1)-423(M). Although tablespace 422 includes multiple data tables 423(1)-423(M), it should be apparent that in other implementations, the tablespace(s) of the data repository may contain only a single data table. Elements of database environment 400 are examples of certain elements of communication system 100. For example, data utilities 432(1)-432(4) are possible examples of data utilities 132, 232(1)-232(X), and 332(1)-332(4); database manager 436 is a possible example of database manager 236; memory 438 is a possible example of memory 238, DBA user terminal 460 is a possible example of user terminal 160; and data repository 420 and its components are possible examples of data repositories 120, 220, and 320 and their components.

FIGS. 4A-4C illustrate various stages of an opportunistic data content discovery scan being performed, which will now be described. With reference to FIG. 4A, an example scenario is shown where data copy utility 432(1) and data unload utility 432(4) are running in database environment 400. Database manager 436 manages access to data repository 420, including read accesses by data copy utility 432(1) and data unload utility 432(4). Data processing region 437 receives requests 402a and 403a from data utilities 432(1) and 432(4), respectively, for access to one or more data tables 423(1)-423(M) in data repository 420. Data processing region 437 also may receive flows of user requests from users via network user terminals (not shown in FIG. 4) and from database administrator(s) via DBA user terminal 460.

At 402b and 403b, data processing region 437 determines the location of a data block that contains the requested data. In this example, data processing region 437 determines the location of the requested data and retrieves the appropriate data rows into memory at 402c and 403c. The data rows retrieved into memory include data rows 450(1) for data copy utility 432(1) and data rows 450(4) for data unload utility 432(4). In one embodiment, the data rows may be retrieved into memory 430 in data blocks until all of data requested by the utilities has been retrieved into memory 438. Data rows 450(1) and 450(4) may each include some or all of the data from tablespace 422. For example, data copy utility 432(1) may be performing a backup function and retrieve all data rows from all data tables 423(1)-423(M) in tablespace 422 of data repository 420. Data unload utility 432(4), however, may only be unloading some of the data tables. Accordingly, only the requested data tables may be retrieved into memory 438. In another example, another utility may only retrieve a portion of the data rows of one or more of the data tables into memory 438. For example, only 50% of the data rows of data table 423(2) may be retrieved into memory. At 402d and 403d, the requested data rows are accessed by the data utilities 432(1) and 432(4).

FIG. 4B illustrates in-memory copy operations being performed to copy data rows 450(1) and 450(4) from their locations in memory 438 to respective new locations in memory 438. At 402e, data copy utility 432(1) initiates an in-memory copy of data rows 450(1). At 402f, data processing region 437 accesses data rows 450(1). At 402g, data processing region 437 copies the data rows to another location in memory 438, shown in FIG. 4B as copied data rows 455(1). At 403e, data unload utility 432(4) initiates an in-memory copy of data rows 450(4). At 403f, data processing region 437 accesses data rows 450(4). At 403g, data processing region 437 copies the data rows to another location in memory 438, shown in FIG. 4B as copied data rows 455(4).

FIG. 4C illustrates the data content discovery scans performed on copied data rows 455(1) and 455(4). Data copy utility 432(1) and data unload utility 432(4) may continue to access the originally retrieved data rows 450(1) and 450(4), respectively, until their processing is completed. For ease of illustration, however, data rows 450(1) and 450(4) and accesses thereto have been omitted from FIG. 4C.

Data copy utility 432(1) performs a handshake with a server hosting an opportunistic discovery scan 444 and provides collected information related to copied data rows 455(1) for the opportunistic discovery scan 444 to use to perform a scan of copied data rows 455(1). At 402h, data copy utility 432(1) provides the collected information to data processing region 437. At 402i, data processing region 437 communicates the collected information to opportunistic discovery scan 444. The collected information can include, for example, a memory address of the new location in memory containing the copied data rows 455(1), an identifier or name of each object (e.g., data table, tablespace) associated with the copied data rows 455(1), and a number of copied data rows associated with each object.

Data copy utility 432(4) also performs a handshake with the server hosting the opportunistic discovery scan 444 and provides collected information related to copied data rows 455(4) for the opportunistic discovery scan 444 to use to perform a scan of copied data rows 455(4). At 403h, data copy utility 432(4) provides the collected information to data processing region 437. At 403i, data processing region 437 communicates the collected information to opportunistic discovery scan 444. The collected information can include, for example, a memory address of the new location in memory containing the copied data rows 455(4), an identifier or name of each object (e.g., data table, tablespace) associated with the copied data rows 455(4), and a number of copied data rows copied associated with each object.

Opportunistic discovery scan 444 can use API 442 to perform a scan of copied data rows 455(1) and copied data rows 455(4). In at least one implementation, API 442 may access the data processing region 437, which accesses copied data rows 455(1) at 404a and 404b and accesses copied data rows 455(4) at 404c and 404d. Opportunistic discovery scan 444 can generate a scan output 465 for each scan performed on copied data rows 455(1) and 455(4). For each object having data rows that are scanned, scan output 465 can include an identifier of the object, a quantity of sensitive data instances identified in the object, a percentage of the object that was scanned.

Scan output 465 can be provided to, or otherwise accessed by, scoring and marking algorithm 446. Based at least in part on the scan output, in at least some scenarios, scoring and marking algorithm 446 can determine that an object contains sensitive data or that the object does not contain sensitive data as previously described herein. In other scenarios, scoring and marking algorithm 446 can determine a score that represents the probability that a particular object contains sensitive data as previously described herein. In both scenarios, the object can be marked to indicate the determination that it contains sensitive data, that it does not contain sensitive data, or that there is a particular probability that it contains sensitive data. An appropriate catalog table(s) of catalog 426 may be marked with a flag and/or score to indicate the sensitive data determinations and/or scores for each object.

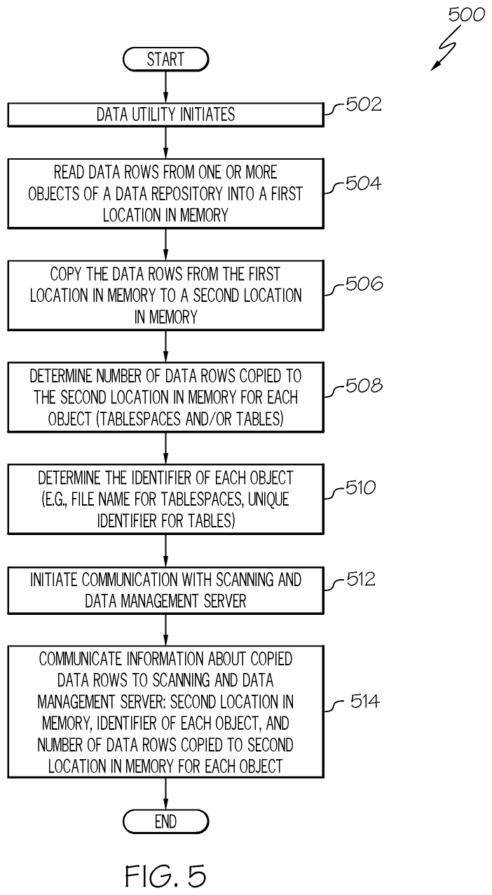

Turning to FIGS. 5-10, various flowcharts illustrate example techniques related to one or more embodiments of a communication system, such as communication system 100, for performing data content discovery scans of a data repository (e.g., 220). In at least one embodiment, one or more sets of operations correspond to activities of FIGS. 5-10. At least some operations may be performed by a database server (e.g., 130, 230) and at least some other operations may be performed by a scanning and data management server (e.g., 140, 240). In another possible implementation, however, operations performed by the database server and the scanning and data management server may be performed by a single machine and/or virtual machine or may be performed across multiple machines and/or virtual machines. Although components of communication system 100 are shown in various arrangements and illustrations throughout the FIGURES, for ease of illustration, the flows of FIGS. 5-10 will be described with reference to components of FIG. 2.

FIG. 5 is a simplified flowchart 500 illustrating an example flow that may be associated with embodiments described herein. In at least one embodiment, one or more operations correspond to activities of FIG. 5. In one example, a database server (e.g., 230), or a portion thereof, may perform at least some of the one or more operations. The database server may comprise means, such as processor 239 and memory 238, for performing the operations. In an embodiment, one or more operations of flow 500 may be performed by a data utility (e.g., 232(1)-232(X)) that executes to perform a specific transaction or function on a data repository (e.g., 220), such as backup/copy, load, unload, or reorganize. While executing, the data utility performs a read operation for one or more data rows in one or more data tables (e.g., 223(1)-223(M)) in a tablespace (e.g., 222) of the data repository.

At 502, the data utility initiates. The data utility may be initiated based on a regularly scheduled day/time, or it may be initiated on demand for example, by a database administrator. At 504, data rows are read from one or more objects (e.g., data tables, tablespaces, indexes, index spaces) of the data repository into a first location in memory.

At 506, the data utility copies the data rows from the first location in memory to a second location in memory. In at least one implementation, a data copy agent (e.g., 233(1)-233(X)) that is integrated with, or called or otherwise triggered by, the data utility may perform an in-memory copy of the read data rows from the first location in memory to the second location in memory.

At 508, the data utility can determine the number of data rows copied to the second location in memory for each object associated with the data rows read into the first location. For example, assume 5000 data rows of 10,000 total data rows in data table 223(1) are retrieved into the first location in memory by the data utility and then copied to the second location, and 7000 data rows of 14,000 total data rows in data table 223(2) are retrieved into the first location in memory by the data utility and then copied to the second location. In this example scenario, the data utility determines that 5000 data rows of data table 223(1) are stored in the second location in memory and that 7000 data rows of data table 223(2) are stored in the second location in memory. The data utility may also determine that 12,000 data rows of tablespace 222 are stored in the second location in memory.

At 510, the data utility determines the identifier of each object associated with the copied data rows in the second location in memory. In at least one embodiment, tablespaces are assigned unique file names within the data repository. Each data table may be assigned an identifier that is unique at least within its tablespace. For example, if data rows from data tables 223(1) and 223(2) of tablespace 222 are read into memory and copied to a second location in memory, the data utility could determine the unique identifier for data table 223(1), the unique identifier for data table 223(2), and the unique file name of tablespace 222.

At 512, the data utility initiates communication with scanning and data management server 240. In at least one implementation, a handshake agent (e.g., 234(1)-234(X)) that is integrated with, or called or otherwise triggered by, the data utility may perform a handshake or communication based on a known protocol to establish communication between the database server and the scanning and data management server.

At 514, the data utility (or handshake agent) communicates collected information about the copied data rows to the scanning and data management server. This collected information can include but is not necessarily limited to the second location (e.g., memory address) in memory where the copied data rows are stored, an identifier of each object associated with the copied data rows, and a number of data rows copied to the second location in memory for each object associated with the copied data rows.

In some scenarios, some of the information may be obtained by the scanning and data management server instead of being collected and provided by the database server. For example, if a tablespace is configured to contain a single data table, then the information collected and communicated by the database server may include the identifier and number of copied data rows of the tablespace, without additional information for the single data table. The identifier of the single data table can be obtained from an appropriate catalog table using the tablespace file name. Also, in this scenario, the number of copied data rows of the tablespace are applicable to the data table.

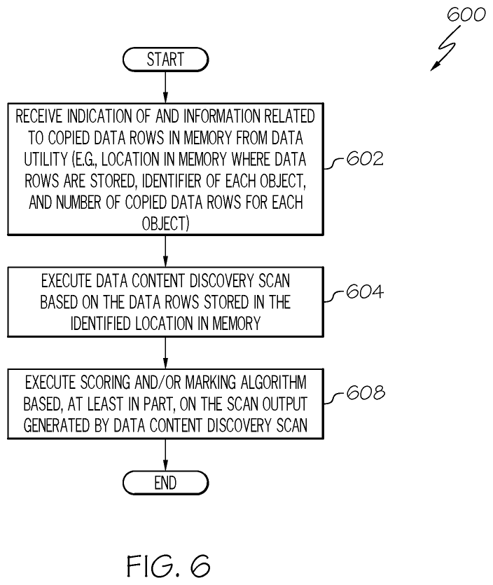

FIGS. 6-10 are simplified flowcharts that illustrate example flows that may be associated with embodiments described herein. In at least one embodiment, one or more sets of operations correspond to activities of FIGS. 6-10. In one example, a scanning and data management server (e.g., 240), or a portion thereof, may utilize at least some of the one or more operations. The scanning and data management server may comprise means, such as processor 249 and memory 248, for performing the operations.

FIG. 6 is a simplified flowchart 600 illustrating an example flow that may be associated with embodiments described herein. In one example, one or more operations corresponding to activities of FIG. 6 may be performed by various components of the scanning and data management server. For example, an API (e.g., 242), data content discovery scans (e.g., 243), and/or a scoring and marking algorithm (e.g., 246), or portions thereof, may perform the one or more operations.

At 602, scanning and data management may receive an indication of, and information related to, copied data rows in memory from a data utility running on a database server, such as database server 230. In at least one embodiment, the data utility may include (or may cooperate with) a handshake agent (e.g., 234(1)-234(X)) to communicate with scanning and data management server 240. The information related to the copied data rows in memory may include, for example, the location in memory where the copied data rows are stored, an identifier of each object associated with the copied data rows, and a number of copied data rows corresponding to each object that is associated with the copied data rows.

At 604, a data content discovery scan is executed based on the copied data rows stored in the identified location in memory. In one example, an opportunistic discovery scan (e.g., 244) is executed to identify instances of possibly sensitive data in the copied data rows.

At 608, a scoring and marking algorithm (e.g., 246) is executed based, at least in part, on a scan output that is generated by the opportunistic discovery scan and provides information related to identified instances of possibly sensitive data.

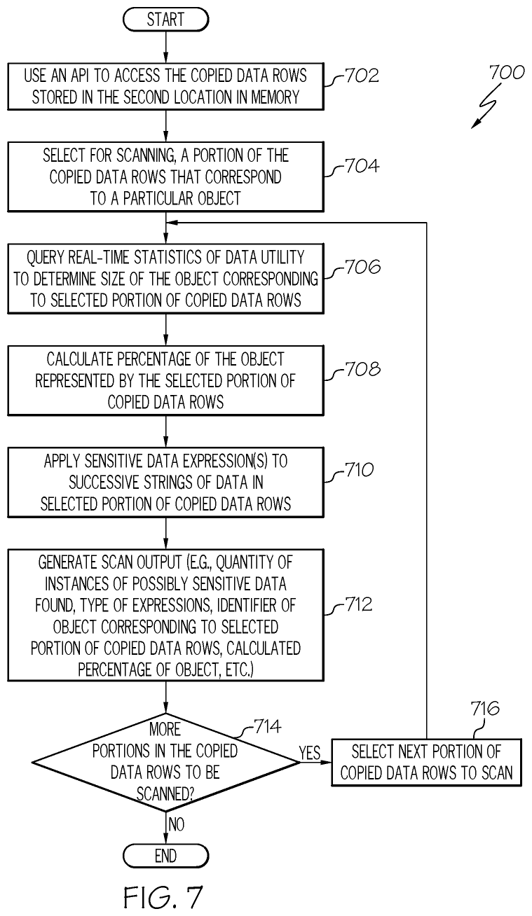

FIG. 7 is a simplified flowchart 700 illustrating an example flow that may be associated with embodiments described herein. In one example, one or more operations corresponding to activities of FIG. 7 may be performed by various components of a scanning and data management server (e.g., 240). For example, an API (e.g., 242) and an opportunistic discovery scan (e.g., 244), or portions thereof, may perform the one or more operations.

At 702, the API may be used by the scanning and data management server to access copied data rows that are stored in a second location in memory in a database server (e.g., 230). A first location in memory is used by a data utility (e.g., 232(1)-232(X)) to first retrieve the data rows from a data repository (e.g., 220) and then copy the data rows from the first location to the second location. The API may know where the copied data rows are stored based on receiving the second location information from the data utility that copied the data rows from the first location in memory to the second location in memory.

At 704, a portion of the copied data rows that corresponds to an object (e.g., data table, tablespace, index, index space) in the data repository is selected for scanning. For example, if the second location in memory contains 20,000 data rows, and only 5000 of those data rows correspond to a first object, then the portion of 5000 data rows corresponding to the first object may be selected for scanning.

At 706, real-time statistics of the data utility can be queried to determine the size of the object corresponding to the selected portion of copied data rows. For example, information indicating 20,000 data rows may be returned by the real-time statistics of the data utility in response to a query for the size of the first object.

At 708, a percentage of the object that is represented by the selected portion of copied data rows may be calculated. This percentage may be calculated using the size of the object that is obtained from querying the real-time statistics of the data utility and the size of the selected portion of the copied data rows, which may be provided in information received from the data utility (or handshake agent). In at least one example, ‘size’ may be represented as a number of data rows. For example, if the size of the object is 20,000 data rows and the selected portion of the copied data rows is 5000, then the calculated percentage is 25%.

It should be noted that, although the percentage of the object may be calculated based on the number of scanned data rows of an object relative to the total number of data rows of the object, any other suitable calculation may be used. Generally, any suitable metrics for the size or amount of data can be used to calculate the percentage of data that is in a particular object (e.g., data table, tablespace, index, index space, etc.) and that is being scanned, relative to the total amount of data contained in the object that is stored in the data repository.

At 710, the selected portion of the copied data rows can be scanned for instances of possibly sensitive data. In at least one embodiment, one or more sensitive data expressions can be applied to successive strings of data in the selected portion of copied data rows. If the expression corresponds to a particular string of data, then an instance of possibly sensitive data is identified and aggregated for the selected portion of copied data rows.

At 712, a scan output is generated (if not already generated) and updated with information related to scanning the selected portion of copied data rows. The scan output can be updated with an identifier (e.g., file name or other identifier) of the object corresponding to the selected portion of copied data rows and the percentage calculated at 708. In addition, if one or more instances of possibly sensitive data are identified in the selected portion of copied data rows, then the scan output can also be updated with information related to the instances that were identified. Such information can include, but is not necessarily limited to, an aggregated quantity of the instances that were found and a type of the expressions that were used to identify the possibly sensitive data. If no instances of possibly sensitive data are identified at 710, then the quantity of the instances in the scan output can be zero and the type of expressions used in the scan may be indicated.

At 714, a determination can be made as to whether more portions in the copied data rows are to be scanned. A determination that more portions are to be scanned may be made if any portions of the copied data rows have not been scanned. If more portions in the copied data rows are to be scanned, then at 716, a next portion of copied data rows are selected for scanning. The flow can pass back to 706, where the real-time statistics of the data utility are queried again to determine the size of the object corresponding to the newly selected portion of copied data rows. Flow may continue to loop through 706-712 until all of the portions of the copied data rows have been selected and scanned, and the scan output has been updated with information related to the results of the scans.

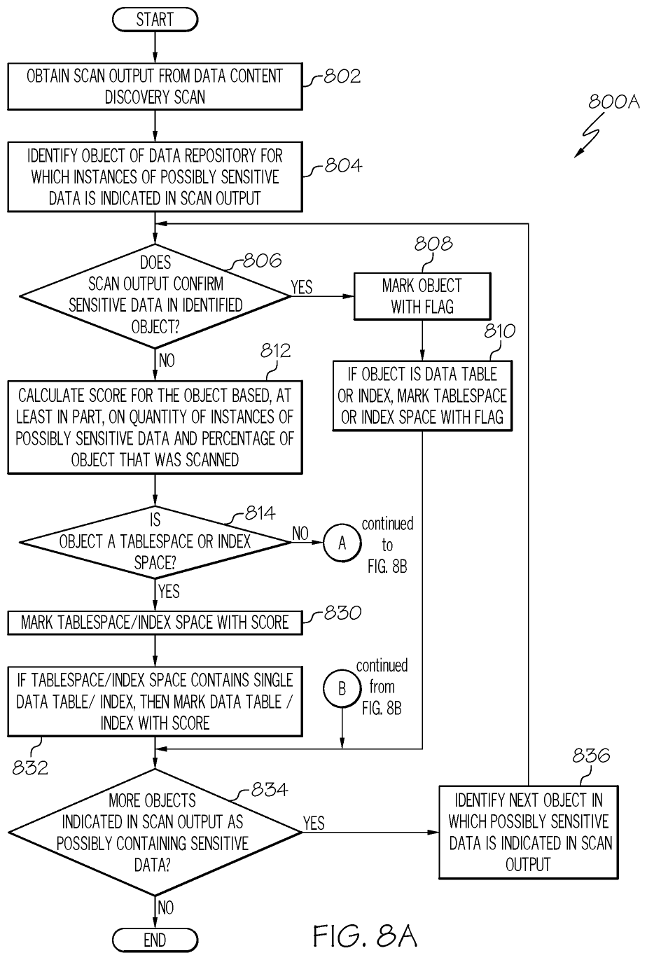

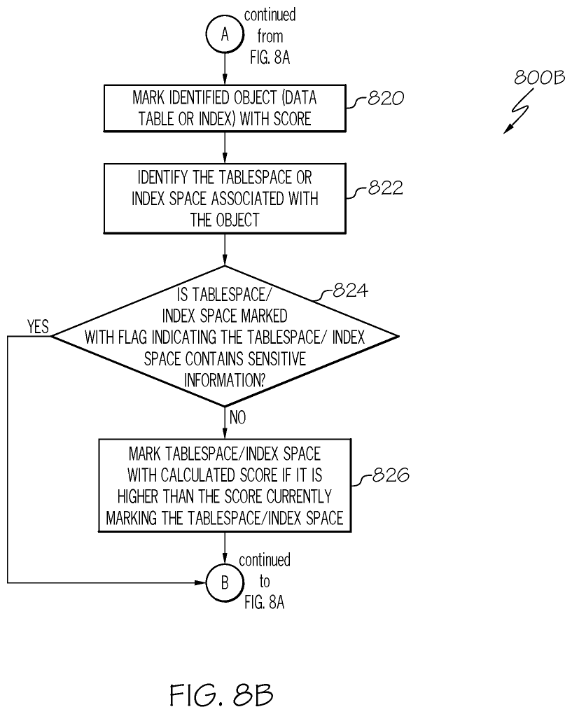

FIGS. 8A-8B are simplified flowcharts 800A-800B illustrating an example flow that may be associated with embodiments described herein. In one example, one or more operations corresponding to activities of FIGS. 8A-8B may be performed by scanning and data management server 240. For example, a scoring and marking algorithm (e.g., 246), or portions thereof, may perform the one or more operations.

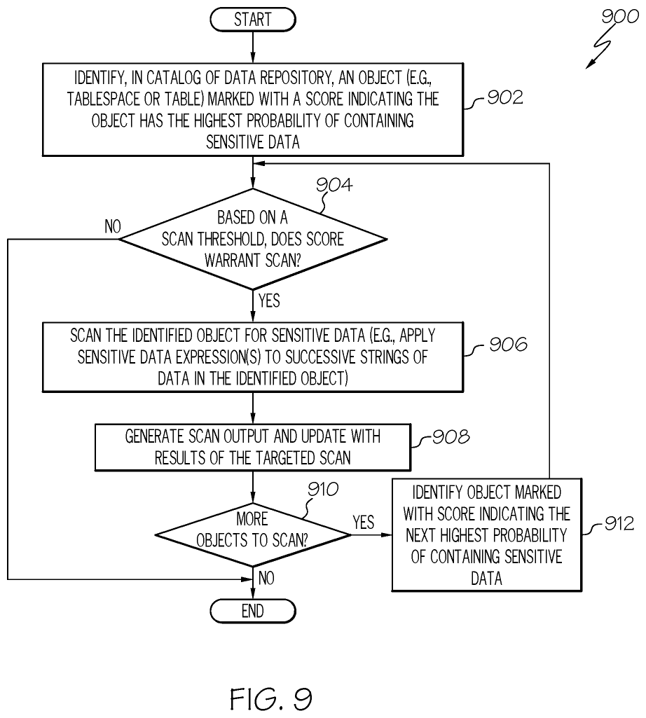

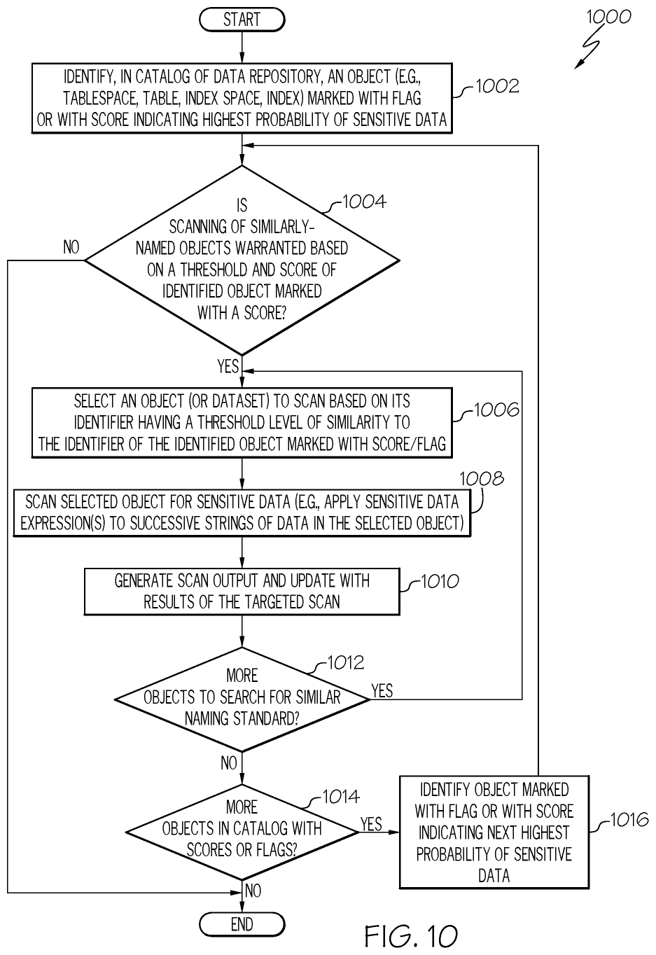

At 802 in FIG. 8A, a scan output is obtained from a data content discovery scan (e.g., 243). The scan output may have been generated by either an opportunistic discovery scan (e.g., 244) as described herein and with particular reference to FIG. 7, or a targeted discovery scan (e.g., 245) as described herein and with particular reference to FIGS. 9-10.

At 804, an object (e.g., data table, tablespace, index space, index) of a data repository (e.g., 220) is identified. The object is identified based on one or more instances of possibly sensitive data that are indicated in the scan output and that are contained in the object.

At 806, a determination is made as to whether the information in the scan output confirms that sensitive data is present in the identified object. In one example, the determination may be made using information in the scan output. In one example, the determination may be based on the percentage of the object that was scanned (e.g., the percentage of data rows in the object that were read into memory and copied to a second location in the memory) and the quantity of instances of possibly sensitive data identified during the scan of the copied data rows stored in the memory. If the entire object was scanned, and if the quantity of instances of possibly sensitive data identified during the scan exceeds an upper threshold, then a determination may be made that the object does contain sensitive data. If the entire object was scanned but the amount of sensitive data identified during the scan does not exceed a lower threshold, then a determination may be made that the object does not contain sensitive data.

In some implementations, if only a portion of the object is scanned, then the object may not be evaluated for definitive determinations as to whether the object contains or does not contain sensitive data. In other implementations, the object may be evaluated for definitive determinations as to whether the object contains or does not contain sensitive data based on a threshold amount of the object being scanned. In this implementation, however, the upper and lower thresholds may be higher and lower, respectively.

In some scenarios, the type of expression that was used to identify the instance of possibly sensitive data may be determinative as to whether sensitive data is present in the identified object. In some implementations, the scan output indicates the type of expressions used to identify possibly sensitive data. For example, if the scan output indicates that an explicit expression is used to scan data rows in an object, such as “Attorney client privileged” or any other explicit information that indicates a high probability of sensitive data, then a determination may be made that the object does contain sensitive data. This determination may be made regardless of the number of data rows in the object that are being scanned.

It should be noted that any other suitable techniques may be utilized to make definitive determinations as to whether an object contains sensitive data or does not contain sensitive data. The non-limiting example techniques described herein are for illustrative purposes only and are not intended to preclude embodiments where other suitable techniques are used in combination with the described example techniques or as an alternative to the described example techniques.

If the scan output confirms that sensitive data was identified in the object (or if any other technique is used to confirm that sensitive data is present in the object), then at 808, the object is marked (e.g., with a flag) to indicate that it contains sensitive data. If the object is a data table or an index, then at 810, the tablespace containing the data table, or the index space containing the index, may also be marked (e.g., with a flag) to indicate that the tablespace or index space contains sensitive data.

In at least one embodiment, the object may be marked by identifying the appropriate catalog table associated with objects having the same type. Within the identified catalog table, a row associated with the object can be selected and the appropriate column within the row may be set to ‘1’ to indicate that sensitive data is contained in the object. It should be understood, however, that any suitable marking technique may be used.

If the scan output does not confirm that sensitive data is contained in the object (or if any other technique that is used does not confirm that sensitive data is contained in the object), then at 812, a score is calculated for the object based, at least in part, on the quantity of instances of possibly sensitive data and the percentage of the object that was scanned.

If the object is a tablespace or index space, as indicated at 814, then at 830, the tablespace or index space is marked with the calculated score. In at least one embodiment, the tablespace or index space may be marked with the score by identifying the appropriate catalog table associated with tablespaces or index spaces. Within the identified catalog table, a row associated with the tablespace or index space can be selected and the calculated score may be stored in the appropriate column within the row to indicate the probability that sensitive data is contained in the tablespace or index space.

At 832, if the tablespace or index space includes a single data table or index, respectively, then the single data table or index may also be marked with the calculated score. In at least one embodiment, the data table or index may be marked with the score by identifying the appropriate catalog table associated with data tables or indexes. Within the identified catalog table, a row associated with the data table or index can be selected and the calculated score may be stored in the appropriate column within the row to indicate the probability that sensitive data is contained in the data table or index.

If the object is not a tablespace or index space, as indicated at 814, then the object may be a data table or an index and flow passes to flowchart 800B of FIG. 8B. At 820, the data table or index is marked with the calculated score. In at least one embodiment, the data table or index may be marked with the score by identifying the appropriate catalog table associated with data tables or indexes. Within the identified catalog table, a row associated with the data table or index can be selected and the calculated score may be stored in the appropriate column within the row to indicate the probability that sensitive data is contained in the data table or index.

At 822, a tablespace associated with the object is identified if the object is a data table. Alternatively, an index space associated with the object is identified if the object is an index.

At 824, a determination is made as to whether the identified tablespace or index space is marked with a flag that indicates sensitive data is present in the tablespace or index space. If the identified tablespace or index space is marked with a flag, then another data table or index within the tablespace or index space has previously been determined to contain sensitive data and the tablespace or index space has been marked accordingly. In this scenario, the tablespace or index space may not be marked with the calculated score.

If the tablespace or index space is not marked with a flag indicating the tablespace or index space contains sensitive data, then at 826, the tablespace/index space may be marked with the calculated score if the calculated score is greater than a score currently marking the tablespace or index space. That is, in at least one embodiment, the tablespace or index space may be marked with the highest score of the respective scores associated with its data tables. Thus, the tablespace or index space may be marked to indicate the highest probability that it contains sensitive data in at least one data table. In at least one embodiment, the tablespace or index space may be marked with the score by identifying the appropriate catalog table associated with tablespaces or index spaces. Within the identified catalog table, a row associated with the tablespace or index space can be selected and the calculated score may be stored in the appropriate column within the row to indicate the probability that sensitive data is contained in the tablespace or index space.

Once the appropriate object or objects are marked (e.g., 810, 826, or 832), then a determination may be made at 834 as to whether more objects are indicated in the scan output as containing instances of possibly sensitive data. If more objects are indicated in the scan output, then at 836, the next object in which possibly sensitive data is indicated in the scan output is identified. Flow may pass back to 806 and continue until all objects indicated as containing instances of possibly sensitive data in the scan output have been marked appropriately (e.g., by flag or score).

Once a it is determined at 834 that no more objects are indicated in the scan output as containing instances of possibly sensitive data, the flow may end.

FIG. 9 is a simplified flowchart 900 illustrating an example flow that may be associated with embodiments described herein. In one example, one or more operations corresponding to activities of FIG. 9 may be performed by a targeted discovery scan (e.g., 245), or portions thereof. This targeted discovery scan may be utilized subsequent to at least one or more of the objects in the data repository being marked with a score.

Scores indicate a probability that an object contains sensitive data. In at least some instances, being marked with a score indicates that only a portion of the data rows of the object have previously been scanned for sensitive data. Thus, the targeted discovery scan may be used to search for objects from the highest probability of containing sensitive data to the lowest probability of containing sensitive data. When found, all of the data rows in these objects may be scanned for sensitive data to attempt to ascertain whether the object does or does not contain sensitive data, to determine an updated probability score based on the entire object.

At 902, appropriate catalog tables of the data repository can be searched for an object marked with a score indicating the highest probability of containing sensitive data. Accordingly, the object with the highest probability of containing sensitive data is identified.

At 904, a determination is optionally made based on a scan threshold as to whether the score of the object warrants another scan. For example, if the probability score is very low, then the object may not need to be scanned. If the score does not warrant scanning, then flow may end since the object is marked with the highest score of the objects found in the catalog table.

If the score of the object warrants a scan, however, then at 906, the identified object may be scanned for sensitive data. For example, data rows of the object may be read into memory, and then sensitive data expressions may be applied to successive strings of data in the read data rows.

At 908, a scan output may be generated (if not already generated) and updated with results of the targeted scan. In at least one embodiment, the scan output may be the same or similar to the scan output generated in FIG. 7. In this scan output, however, the percentage of the object that has been scanned may be 100%.

At 910, a determination is made as to whether there are more objects to scan. If there are more objects to scan (e.g., more objects marked with scores in the catalog tables), then at 912, the next object is identified that is marked with a score indicating the next highest probability of containing sensitive data.

Flow may pass back to 904 and processing may continue until the score does not warrant a scan based on the scan threshold (e.g., at 904) or until there are no more objects to scan (e.g., at 910).

FIG. 10 is a simplified flowchart 1000 illustrating an example flow that may be associated with embodiments described herein. In one example, one or more operations corresponding to activities of FIG. 10 may be performed by a targeted discovery scan (e.g., 245), or portions thereof. This targeted discovery scan may be utilized subsequent to at least one or more of the objects in the data repository being marked with a score and/or a flag.

In at least one embodiment, scores indicate a probability that an object contains sensitive data, while flags indicate a determination that an object contains sensitive data or a determination that an object does not contain sensitive data, depending on the value of the flag. In at least some scenarios, the flag may contain a null value if the object is marked with a score. The targeted discovery scan associated with FIG. 10 may perform operations to search for objects that are marked with a flag, indicating the objects contain sensitive data and then to search for objects in order of their scores from the highest probability of containing sensitive data to the lowest probability of containing sensitive data. The identifier (e.g., file name or other unique identifier) of an object found in the search may be used to search for and scan other objects in the data repository having a similar identifier.

At 1002, catalogs of the data repository are searched for an object marked with a flag or a score. Any objects marked with a flag that indicates the object contains sensitive data (e.g., marked with a ‘1’ bit) may be identified first. If no objects are marked with a flag that indicates the object contains sensitive data, then objects may be identified based on objects marked with the highest score to objects marked with the lowest score. Based on the search, a marked object that has been determined to contain sensitive data (e.g., marked with a flag) or that has the highest probability of containing sensitive data is identified.

Optionally at 1004, a determination can be made based on a scan threshold, as to whether the score of the object warrants targeting other similarly-named objects for scanning. For example, if the probability score is very low, then the probability may not warrant consuming the resources needed to search for and scan other similarly-named objects. If the score does not warrant scanning, then flow may end since the identified marked object is marked with the highest score of objects being searched in the catalog tables. If the identified marked object is marked with a flag, then the determination at 1004 may be bypassed since a flag marking can indicate that the object contains sensitive data.

If the score of the identified object warrants a scan, however, then at 1006, appropriate catalog tables (e.g., catalog table associated with tablespaces if the identified object is a tablespace, catalog table associated with tables if the identified object is a table, etc.) are searched for objects having an identifier (e.g., file name or other unique identifier) with a threshold level of similarity to the identifier of the identified object. If the threshold level of similarity is met for a particular object indicated in a catalog table, then the particular object is selected for scanning. It should be noted that in at least some embodiments, the object selected for scanning may be a dataset (e.g., a virtual storage access method (VSAM) file). A VSAM file may be connected to one or more data tables and may have its own unique file name. In at least some implementations, a VSAM file can be associated with multiple data tables within a tablespace.

In one example, a threshold level of similarity can be based on certain parts or levels of the identifier. For example, a filename may have multiple parts or levels separated by periods. For illustration purposes, assume the identified object has a file name of Accounts.Customers.US.NY. In this scenario, the data repository may be searched for other objects having a file name that starts with ‘Accounts.Customers’. Thus, the threshold level of similarity in this case is an object having a file name that matches at least the first two levels of the file name of the identified object. However, naming conventions in a data repository may vary significantly across different data repositories. Therefore, it should be apparent that a threshold level of similarity may be implemented in numerous other ways depending on particular needs and implementations.

At 1008, the selected object may be scanned for sensitive data. For example, data rows of the object may be read into memory, and then sensitive data expressions may be applied to successive strings of data in the read data rows.

At 1010, a scan output may be generated (if not already generated) and updated with results of the targeted scan. In at least one embodiment, the scan output may be the same or similar to the scan output generated in FIG. 7. In this scan output, however, the percentage of the object that has been scanned may be 100%.

At 1012, a determination is made as to whether the catalog tables contain information related to more objects to be evaluated for a similar naming convention to the identifier of the currently identified object. If there are more objects to search in the catalog tables, then flow may pass back to 1006, where appropriate catalog tables are searched for objects having an identifier with a threshold level of similarity to the identifier of the identified object. Flow may continue until the appropriate catalog tables have been thoroughly searched for objects having similar naming conventions to the identified marked object.

At 1014, a determination is made as to whether there are more objects in the catalog tables that are marked with flags or scores. If there are more objects marked with flags indicating that the objects contain sensitive data or with scores indicating the objects have a certain probability of containing sensitive data, then at then at 1016, the next object is identified that is marked with a flag or a score indicating the next highest probability of containing sensitive data.

Flow may pass back to 1004 and processing may continue until the score of the identified object does not warrant searching and scanning other similarly-named objects based on a scan threshold (e.g., at 1004) or until there are no more objects marked with flags or scores in the appropriate catalog tables (e.g., at 1014).

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed sequentially, substantially concurrently, or in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that all variations of the terms “comprise,” “include,” and “contain,” when used in this specification, specify the presence of stated features, integers, steps, operations, elements, and/or components, but do not preclude the presence or addition of one or more other features, integers, steps, operations, elements, components, and/or groups thereof.

As used herein, unless expressly stated to the contrary, use of the phrase ‘at least one of’ and ‘one or more of’ refers to any combination of the named elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Also, references in the specification to “one embodiment,” “an embodiment,” “some embodiments,” etc., indicate that the embodiment(s) described may include a particular feature, structure, or characteristic, but every embodiment may or may not necessarily include that particular feature, structure, or characteristic. Moreover, such phrases are not necessarily referring to the same embodiment. Additionally, unless expressly stated to the contrary, the terms ‘first’, ‘second’, ‘third’, etc., are intended to distinguish the particular noun (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements, that are not necessarily limited by any order, rank, importance, temporal sequence, or hierarchy of the two elements.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
identifying a first location in memory containing first data rows copied from a second location in the memory containing second data rows retrieved from one or more objects in a data repository;
selecting a portion of the first data rows to be scanned, the portion of the first data rows corresponding to a first object of the one or more objects;
performing a scan of the portion of the first data rows;
calculating a probability that the first object contains sensitive data based, at least in part, on one or more instances of possibly sensitive data identified during the scan; and
marking the first object in the data repository with a sensitive data indicator, the sensitive data indicator based, at least in part, on the probability that the first object contains sensitive data.

2. The method of claim 1, wherein the first object is one of a tablespace, a table within a tablespace, or an index space.

3. The method of claim 1, further comprising:
receiving a memory address of the first location in the memory from a data utility process, wherein the first data rows are copied from the second data rows by the data utility process subsequent to the data utility process reading the second data rows into the second location of the memory from the data repository.

4. The method of claim 3, wherein the selecting the portion of the first data rows to be scanned is based on information received from the data utility process, wherein the information identifies the first object and a number of data rows of the first object that are stored in the first location of the memory.

5. The method of claim 1, further comprising:
querying real-time statistics of the first object to determine a size of the first object; and
calculating a percentage of a size of the first object represented by a size of the portion of the first data rows, wherein the calculating the probability that the first object contains sensitive data is based, in part, on the percentage of the size of the first object represented by the size of the portion of the first data rows.

6. The method of claim 5, further comprising:
generating a scan output including an indication of the one or more instances of possibly sensitive data found during the scan, an identifier of the first object, the percentage of the size of the first object represented by the size of the portion of the first data rows, and information related to the one or more instances of possibly sensitive data identified in the scan.

7. The method of claim 1, wherein the marking includes storing a score as the sensitive data indicator in a catalog of the data repository, wherein the catalog is associated with the first object and the score is mapped to an identifier of the first object.

8. The method of claim 7, further comprising:
determining that the first object contains sensitive data based on a sensitive data threshold being satisfied by the probability that the first object contains sensitive data; and
responsive to the determining that the first object contains sensitive data, marking the first object by storing a flag as the sensitive data indicator in a catalog of the data repository, wherein the flag is mapped to an identifier of the first object and indicates that the first object contains sensitive data.

9. The method of claim 1, wherein the first data rows in the first location in memory are accessed via an application programming interface (API).

10. The method of claim 1, further comprising, subsequent to marking the first object:
selecting the first object based on the sensitive data indicator; and
performing a second scan of the first object.

11. The method of claim 1, further comprising, subsequent to marking the first object:
identifying the first object based on the sensitive data indicator;
selecting a second object based on a second identifier of the second object having a threshold level of similarity to a first identifier of the first object; and
performing a second scan on the second object.

12. The method of claim 11, wherein the first identifier of the first object is a first file name in the data repository and the second identifier of the second object is a second file name in the data repository.

13. The method of claim 12, wherein the second object is identified by searching a catalog associated with the one or more objects in the data repository for file names having the threshold level of similarity to the first file name.

14. A non-transitory computer readable medium comprising program code that is executable by a computer system to perform operations comprising:
identifying a first location in memory containing first data rows copied from a second location in the memory containing second data rows retrieved from a first object in a data repository;
querying real-time statistics of the first object to determine a size of the first object;
calculating a percentage of a size of the first object represented by a size of the first data rows;
performing a scan of the first data rows;
calculating a probability that the first object contains sensitive data based, at least in part, on one or more instances of possibly sensitive data identified during the scan and the percentage of the first object represented by the first data rows; and
marking the first object in the data repository with a sensitive data indicator, the sensitive data indicator based, at least in part, on the probability that the first object contains sensitive data.

15. The non-transitory computer readable medium of claim 14, wherein the marking includes associating the sensitive data indicator to a first identifier of the first object.

16. The non-transitory computer readable medium of claim 15, wherein the program code is executable by the computer system to perform further operations comprising:
subsequent to the marking, selecting the first object based on determining that the sensitive data indicator associated with the first identifier of the first object indicates a higher probability of the first object containing sensitive data than other objects in the data repository; and
performing a second scan of the first object.

17. The non-transitory computer readable medium of claim 15, wherein the program code is executable by the computer system to perform further operations comprising:
subsequent to the marking, identifying the first object based on determining that the sensitive data indicator associated with the first identifier of the first object indicates the first object contains sensitive data;
selecting a second object based on a second identifier of the second object having a threshold level of similarity to the first identifier of the first object; and
performing a second scan on the second object.

18. An apparatus comprising:
a processor;
a data repository for storing a tablespace comprising one or more tables; and
one or more instructions that are executable by the processor to:
identify a first location in memory containing first data rows copied from a second location in the memory containing second data rows retrieved from the tablespace;
select a portion of the first data rows to be scanned, wherein the portion of the first data rows corresponds to a first table of the tablespace;
perform a scan of the portion of the first data rows;
calculate a probability that the first table contains sensitive data based, at least in part, on one or more instances of possibly sensitive data identified during the scan; and
mark the first table in the data repository with a first sensitive data indicator, the first sensitive data indicator based, at least in part, on the probability that the first table contains sensitive data.

19. The apparatus of claim 18, wherein the instructions are executable by the processor to further:
mark the tablespace with a second sensitive data indicator based on determining that each of the one or more tables in the tablespace are marked with a respective sensitive data indicator mapped to a respective identifier.

20. The apparatus of claim 18, wherein the instructions are executable by the processor to further:
mark the tablespace with a second sensitive data indicator based on the one or more tables including only the first table, wherein the second sensitive data indicator corresponds to the first sensitive data indicator.
